(19) United States
(12) Patent Application Publication
(10) Pub. No.: US 2019/0046930 A1
(43) Pub. Date: Feb. 14, 2019

(54) MEMBRANE FILTRATION DEVICE, FILTRATION MEMBRANE CLEANING METHOD, AND METHOD FOR MANUFACTURING FILTRATION MEMBRANE

(71) Applicant: Mitsubishi Electric Corporation, Chiyoda-ku (JP)

(72) Inventors: Eiji IMAMURA, Chiyoda-ku (JP); Tokiko YAMAUCHI, Chiyoda-ku (JP); Nozomu YASUNAGA, Chiyoda-ku (JP)

(73) Assignee: Mitsubishi Electric Corporation, Chiyoda-ku (JP)

(21) Appl. No.: 16/078,219

(22) PCT Filed: Mar. 4, 2016
(86) PCT No.: PCT/JP2016/056796

§ 371 Date: Aug. 21, 2018

(51) Int. Cl. B01D 65/02; B01D 67/00; C02F 3/12

(52) U.S. Cl. CPC B01D 65/02; B01D 67/0093; C02F 3/1273; C02F 2209/03; B01D 2321/40; C02F 2303/16; B01D 2321/168

(57) ABSTRACT

A membrane filtration device including a filtration mode for filtrating water to be treated by passing the water to be treated from a primary side to a secondary side of a filtration membrane and a filtration membrane cleaning mode for cleaning the filtration membrane by passing ozone water from the secondary side to the primary side of the filtration membrane, wherein the membrane filtration device includes an inter-membrane differential pressure controller for controlling an inter-membrane differential pressure ΔP, and is configured such that in the filtration membrane cleaning mode, the inter-membrane differential pressure controller performs control to gradually lower the inter-membrane differential pressure ΔP twin a predetermined initial differential pressure ΔP1 to a final differential ΔP2, which is a value lower than the ΔP1.

### TECHNICAL FIELD

The present invention relates to a membrane separation technology in which water to be treated containing impurity is filtrated by using a filtration membrane and a method for manufacturing a filtration membrane.

### BACKGROUND ART

Regarding water treatments such as a clean water treatment, a sewage treatment, etc., a liquid-solid separation technology, in which a contamination material which is contained in water to be treated is separated from water to be treated so as to obtain clean treated water, has been widely performed. For example, a liquid-solid separation technology includes an aggregation precipitation technology in which an aggregating agent is added to water to be treated so as to make a contamination material which is contained in water to be treated aggregated and precipitated by gravity to be separated, a pressure looming technology in which micro bubble is injected in water to be treated including an aggregated material so as to make an aggregated material absorbed by micro bubble to be loomed and separated. However, regarding the above mentioned technologies, there are problems such that performing treatment is unstable because the above mentioned technologies are extremely susceptible to the property of water to be treated or an aggregated material, a water temperature, water flow, etc., and also a large precipitation water tank and a looming separation tank are necessary.

On the other hand, recently, as an alternative technology, a membrane filtration technology using filtration membrane is widely introduced. According to the above mentioned technology, by using a membrane having an infinite number of holes on a surface, water to be treated is filtrated so as to perform a liquid-solid separation. Membranes are broadly divided into an inorganic membrane which is made of an inorganic material such as ceramic, and an organic membrane which is made of a polymeric organic polymer.

According to the above mentioned technology, when a size of a contamination material in water to be treated is larger than a diameter of a hole of a membrane, a contamination material in water to be treated can be surely separated and eliminated, as a result, extremely clean treated water can be stably obtained. However, there is a problem such that, when filtration treatment is performed, a contamination material is accumulated on a surface of a membrane, a hole of a membrane is slogged with the accumulated contamination material, as a result, performing filtration treatment becomes difficult. Especially, a hydrophobic organic membrane has high affinity with a hydrophobic contamination material which is contained in water to be treated, therefore, a hydrophobic organic membrane is easily slogged. Consequently, it is difficult to stably perform filtration treatment for a long period.

As above mentioned, in a case where a membrane is slogged, it is necessary to recover a filtration ability by performing cleaning using a chemical agent such as an oxidizing agent. Regarding a method of cleaning using a chemical agent, “in line cleaning” in which from a secondary side to a primary side of a membrane, that is, a direction which is opposite to a direction when water to be treated is filtrated, a chemical agent is washed back, is well known. For example, in Patent Document 1, a cleaning method, in which when in line cleaning is performed, at least one of injection concentration of a chemical agent, injection speed of a chemical agent and injection pressure of a chemical agent is varied, is described.

Further, in Patent Document 2, a method of cleaning out strong dirt so as to clean uniformly a membrane by making a differential pressure between inside of a membrane and outside of a membrane when in line cleaning is performed, that is, ‘inter-membrane differential pressure’ a predetermined range according to an inter-membrane differential pressure when a filtration treatment is performed, is described. Further, in a case where a hydrophobic membrane is used for filtrating, by making a membrane to be hydrophilic, filtration performance can be heightened or it is possible to make a membrane not to be slogged. In Patent Document 3, a method for making a membrane to be hydrophilic using ozone of a hydrophobic organic membrane is disclosed. According to a method which is disclosed in Patent Document 3, a hydrophobic organic membrane is soaked in ozone water or ozone water is injected to a membrane which is modularized so as to make ozone water and a membrane contacted, consequently, a hydrophobic organic membrane is made to be hydrophilic.

### PRIOR ART DOCUMENT

### Patent Document

[Patent Document 1]

JP 2007-61697A

[Patent Document 2]

International publication WO2011-048681A1

[Patent Document 3]

JP 1993-317663A

### SUMMARY OF THE INVENTION

### Problems to be Solved by the Invention

When a membrane is cleaned or a membrane is made to be hydrophilic, it is important to uniformly contact a membrane and a chemical solution. Inventions which are disclosed by Patent Document 1 and Patent Document 2 aim to decrease unevenness of cleaning when in line cleaning is performed so as to heighten a cleaning effect. However, according to a method which is disclosed by Patent Document 1, for example, when pressure of initial cleaning is not sufficient, a chemical solution does not reach an edge part of a membrane (a part which is the farthest from a point where a chemical solution is injected) and in the vicinity of the part, consequently, a membrane and a chemical solution cannot be contacted sufficiently. On the other hand, in some cases, pressure is given too extremely, as a result, damage of a membrane is generated. Further, even by a method which is disclosed by Patent Document 2, depending on a length or a variety of a membrane to be used, in the same way as the above mentioned, a chemical solution does not reach sufficiently and consequently a membrane and a chemical solution do not contact sufficiently.

Present invention aims to solve the above mentioned problems, and provides a membrane filtration device and a method for cleaning a filtration membrane in which a membrane and a chemical solution for cleaning a membrane or a chemical solution for making a membrane to be hydrophilic can be contacted efficiently.

### Means for Solving Problems

A membrane filtration device according to present invention has a filtration mode in which by passing water to be treated from a primary side to a secondary side of a filtration membrane, the water to be treated is filtrated, and a filtration membrane cleaning mode in which by passing ozone water from the secondary side to the primary side of the filtration membrane, the filtration membrane is cleaned, and comprises an inter-membrane differential pressure controller which controls an inter-membrane differential pressure ΔP which is a differential between liquid pressure at the primary side of the filtration membrane and liquid pressure at the secondary side of the filtration membrane, and in the filtration membrane cleaning mode, the inter-membrane differential pressure controller controls to gradually decrease the inter-membrane differential pressure ΔP from an initial differential pressure ΔP₁ which is sot in advance to a final differential pressure ΔP₂ which is a value smaller than a value of the ΔP₁.

Further, a filtration membrane cleaning method according to present invention is a filtration membrane cleaning method which has a filtration treatment process in which by passing water to be treated from a primary side to a secondary side of a filtration membrane, the water to be treated is filtrated and subsequently, a filtration membrane cleaning process in which by passing ozone water from the secondary side to the primary side of the filtration membrane, the filtration membrane is cleaned. In the filtration membrane cleaning process, an inter-membrane differential pressure ΔP which is a differential between liquid pressure at the primary side of the filtration membrane and liquid pressure at the secondary side of the filtration membrane is gradually decreased from an initial differential pressure ΔP₁ which is set in advance to a final differential pressure ΔP₂ which is a value smaller than a value of the ΔP₁.

Further, a method for manufacturing a filtration membrane according to present invention is a method for manufacturing a filtration membrane for filtrating liquid by passing the liquid from a primary side to a secondary side, and comprises a filtration membrane hydrophilization process in which by-passing ozone water from the secondary side to the primary side of the filtration membrane so as to hydrophilize the filtration membrane, and in the filtration membrane hydrophilization process, an inter-membrane differential pressure ΔP which is a differential between pressure at the primary side of the filtration membrane and pressure at the secondary side of the filtration membrane is gradually decreased from an initial inter-membrane differential pressure ΔP₁ which is set in advance to a final differential pressure ΔP₂ which is smaller than a value of ΔP₁ so as to pass ozone water.

### Effects of Invention

According to present invention, even when any membrane is used, proper injecting of a chemical solution considering any property of a membrane such as a length or the degree of dirty can be performed, consequently, without damaging a membrane, a membrane and a chemical solution can be contacted uniformly. As a result, an effect of excellent cleaning and an effect of hydrophilic processing can be obtained.

### BRIEF DESCRIPTION OF DRAWINGS

FIG. 1 is a schematic view showing a configuration of a membrane filtration device according to Embodiment 1 of present invention.

FIG. 2 is a drawing showing an example of a configuration of an ozone water generator of a membrane filtration device according to Embodiment 1 of present invention.

FIG. 3 is a drawing showing another example of a configuration of an ozone water generator of a membrane filtration device according to Embodiment 1 of present invention.

FIG. 4 is a drawing showing an example of the details of a filtration membrane of a membrane filtration device according to Embodiment 1 of present invention.

FIG. 5 is a drawing showing another example of the details of a filtration membrane of a membrane filtration device according to Embodiment 1 of present invention.

FIG. 6 is a drawing describing the operation of a membrane filtration device according to Embodiment 1 of present invention.

FIG. 7 is a flow chart describing the operation of a membrane filtration device according to Embodiment 1 of present invention.

FIG. 8 is a schematic view showing the configuration of a device for performing a method for manufacturing a filtration membrane according to Embodiment 2 of present invention.

FIG. 9 is a flow chart showing a filtration membrane hydrophilic process in a method for manufacturing a filtration membrane according to Embodiment 2 of present invention.

FIG. 10 is a graph showing the result of Example 1 of present invention.

FIG. 11 is a graph showing the result of Example 2 of present invention.

FIG. 12 is a graph showing the result of Example 3 of present invention.

FIG. 13 is a diagram showing the transition of an inter-membrane differential pressure in Examples 4 to 6 and comparative Examples 1 to 4.

### EMBODIMENTS FOR CARRYING OUT THE INVENTION

Embodiments of present invention will be described in the following. Embodiments in the following are examples of present invention, and present invention will not be limited to embodiments in the following.

### Embodiment 1

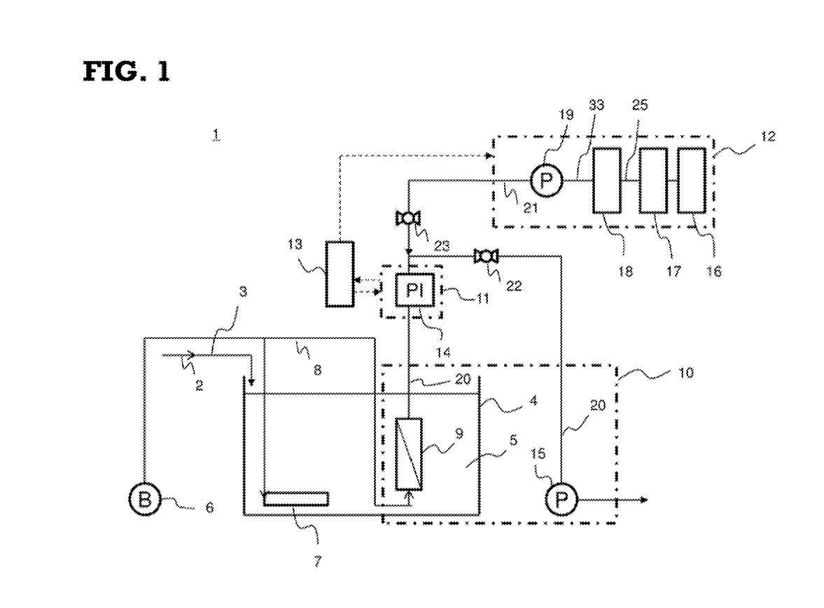

FIG. 1 is a diagram showing the configuration of a membrane filtration device according to Embodiment 1 of present invention. A membrane filtration device 1 shown in FIG. 1 is an example in which present invention is applied to an immersion type membrane separation activated sludge method. In Embodiment 1, water to be treated may be any derived water, for example, water to be treated may include drainage containing an abundance of organic contamination material such as drainage of food processing plant, city sewer, etc., drainage of electronic industry such as industry related to semiconductor, or river water which will be an objective for water treatment. That is, according to present invention, same effect can be obtained even when water to be treated has any property.

The membrane filtration device 1 shown in FIG. 1 comprises a water to be treated introducing pipe 3, a water tank 4, a blower 6, a diffusing device 7, an air introducing pipe 8, a filtration treatment part 10, a pressure measuring part 11, an ozone water injection treatment device 12, an inter-membrane differential pressure controller 13, a valve 22 and a valve 23. Further, the filtration treatment part 10 comprises a filtration membrane 9, a treated water transporting pipe 20 and a filtrating pump 15, and the pressure measuring part 11 comprises a differential pressure gauge 14, and the ozone water injection treatment device 12 comprises an ozone generator 16, an ozone concentrator 17, an ozone water generator 18, an ozone water injecting pump 19, an ozone water injecting pipe 21, etc. As the operation, the membrane filtration device 1 comprises a filtration mode in which the water to be treated 2 is filtrated by the filtration membrane 9 and a filtration membrane cleaning mode in which ozone water is passed in the filtration membrane 9 in a direction which is opposite to a direction of a filtration mode so as to clean the filtration membrane 9.

In a filtration mode, the water to be treated 2 is introduced to the water tank 4 via the water to be treated introducing pipe 3. In the water tank 4, activated sludge 5 is stored and an organic contamination material which is contained in the water to be treated 2 is decomposed and removed. The water to be treated 2 which is purged through a predetermined residence time is sucked by the filtrating pump 15 and is filtrated by the filtration membrane 9, and treated water which is obtained is discharged through the treated water transporting pipe 20 to latter stage. In a process of the filtration mode, a differential pressure between a primary side that is a side of un-permeated water and a secondary side, that is a side of permeated water of the filtration membrane 9, that is, an inter-membrane differential pressure is measured by a pressure measuring part 11, that is, a differential pressure gauge 14. The pressure measuring part 11 may be comprised only by a measuring device which can measure an inter-membrane differential pressure as a discrete component such as a differential pressure gauge 14, also the pressure measuring part 11 may have the configuration in which an inter-membrane differential pressure is calculated by using combination of a device which measures only pressure in the treated water transporting pipe 20 and calculating equipment which is provided separately. That is, the pressure measuring part 11 may be equipment or the configuration by which an inter-membrane differential pressure can be measured and is not limited to the configuration shown in FIG. 1.

An inter-membrane differential pressure which is measured will be transmitted to the inter-membrane differential pressure controller 13. When an inter-membrane differential pressure which is measured reaches a predetermined value by which cleaning of a filtration membrane is judged to be necessary, a filtration mode will be stopped, a filtration mode will be switched to a filtration membrane cleaning mode in which by an ozone water injection treatment device 12, an ozone water injection treatment is performed from a secondary side to a primary side of the filtration membrane 9. Further, in a filtration mode, a valve 22 is opened and a valve 23 is closed, however, in a filtration membrane cleaning mode, the valve 22 is closed and the valve 23 is opened. In the ozone water injection treatment device 12, ozone gas which is generated by the ozone generator 16 is concentrated by the ozone concentrator 17 so as to be exhausted as ozone gas having high concentration, the ozone gas having high concentration is introduced to the ozone water generator 18 so as to generate ozone water, by the ozone water injecting pump 19, ozone water which is generated is injected to the filtration membrane 9 and the filtration membrane 9 is treated.

Here, as the ozone generator 16, any generator which can generate ozone gas is acceptable, for example, a silent discharge type ozone generator using a glass electrode is taken as an example. Further, by introducing the ozone concentrator 17, ozone gas having higher concentration can be obtained. As the ozone concentrator 17, a concentrator using silica gel as an absorbent may be taken as an example, however, any concentrator having the configuration in which ozone gas can be concentrated and concentrated gas can be taken out freely is acceptable. By providing the ozone concentrator 17, ozone gas having higher concentration can be used, ozone concentration in ozone water which is generated by the ozone water generator 18 can be increased and ozone water injection treatment can be completed in shorter time. However, the ozone concentrator 17 is not necessarily required in present invention.

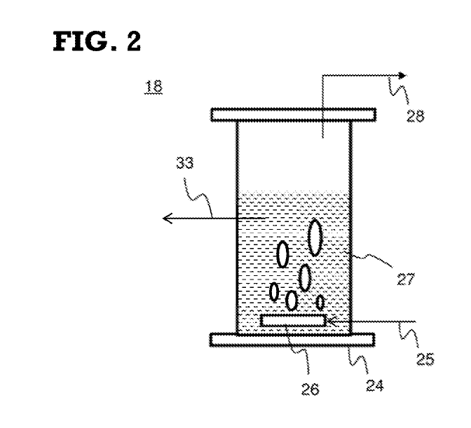

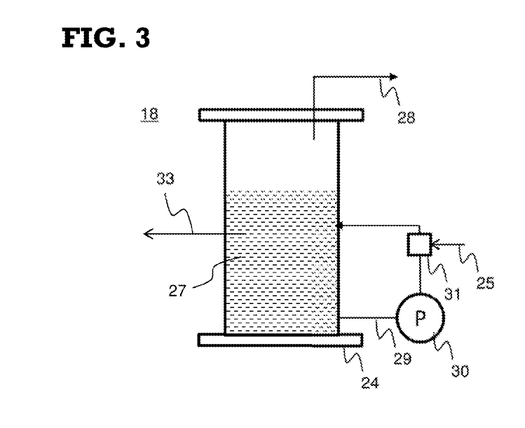

Regarding the configuration of the ozone water generator 18, the configurations shown in FIG. 2 and FIG. 3 are taken as an example. In FIG. 2, the ozone water generator 18 comprises an ozone water tank 24, an ozone gas introducing pipe 25, an ozone gas diffusing device 26, and an exhausted ozone gas exhausting pipe 28. Ozone gas which is exhausted by the ozone generator 16 or the ozone concentrator 17 will be dissipated to the ozone water tank 24 via the ozone gas introducing pipe 25 and the ozone gas diffusing device 26. In the ozone water tank 24, solvent water 27 is stored and by contacting the solvent water 27 and ozone gas, ozone water will be generated. Ozone water which is generated is injected to the filtration membrane 9 from an ozone water pipe 33 through the ozone water injecting pipe 21 by the ozone water injecting pump 19. Ozone gas which is not solved will be exhausted through the exhausted ozone gas exhausting pipe 28.

On the other hand, in FIG. 3, the ozone water generator 18 comprises the ozone water tank 24, the ozone gas introducing pipe 25, the exhausted ozone gas exhausting pipe 28, an ozone water circulating pipe 29, an ozone water circulating pump 30 and an ejector 31. The solvent water 27 which is stored in the ozone water tank 24 will be taken out by the ozone water circulating pump 30 through the ozone water circulating pipe 29 so as to be circulated. On the other hand, ozone gas which is exhausted by the ozone generator 16 or the ozone concentrator 17 will be introduced to the ejector 31 which is provided on the ozone water circulating pipe 29 through the ozone gas introducing pipe 25. That is, in a process in which the solvent water 27 flows in the ozone water circulating pipe 29, the solvent water 27 contacts with ozone gas through the ejector 31 so as to be ozone water. Ozone water which is generated is injected to the filtration membrane 9 from the ozone water pipe 33 through the ozone water injecting pipe 21 by the ozone water injecting pump 19. Ozone gas which is not solved will be exhausted through the exhausted ozone gas exhausting pipe 28. The configurations shown in FIG. 2 and FIG. 3 are an example of the ozone water generator 18, and the configuration of the ozone water generator 18 is not limited to that of FIG. 2 and FIG. 3, and any generator having the configuration in which ozone water can be generated is acceptable. In addition to the configuration in which ozone water can be generated, by adding an adjustment system of PH and water temperature of the solvent water 27 to the configuration, ozone water can be generated more efficiently. Regarding the solvent water 27, treated water (permeated water) which is obtained by the filtration treatment part 10 may be introduced and used, or ion exchange water, pure water or extremely pure water is acceptable.

As described in the above, when a chemical solution such as ozone water, etc. is injected from a secondary side to a primary side of a filtration membrane, there is a problem such that a chemical solution and a filtration membrane cannot be contacted uniformly. Especially, inventors of present invention found a problem, that is, according to any existing invention or combination of existing inventions, deficiency and excess of pressure when a chemical solution is injected is generated, a chemical solution can not sufficiently reach an edge part of a filtration membrane or in the vicinity of an edge part, cleaning or hydrophilic treatment cannot be sufficiently performed or a filtration membrane may be damaged. Inventors of present invention grapple with the above mentioned problem earnestly, as a result, the inventors found out such that regarding ozone water injection treatment, by considering the property of membrane and starting injection of a chemical solution with proper pressure and decreasing the pressure to a predetermined injection pressure, a chemical solution can be permeated efficiently to an edge part of a membrane and in the vicinity of an edge part.

That is, in the inter-membrane differential pressure controller 13, an inter-membrane differential pressure, which should be given to a filtration membrane when ozone water injection treatment is performed according to equation (1), is set, and based on the set value, injecting of ozone water is performed by the ozone water injection treatment device 12.

ΔP=f×α×L (1)

Here, ΔP indicates ozone water injecting inter-membrane differential pressure (kPa), f indicates coefficient (m⁻¹), α indicates un-permeability potential (kPa), and L indicates a length of a filtration membrane (m).

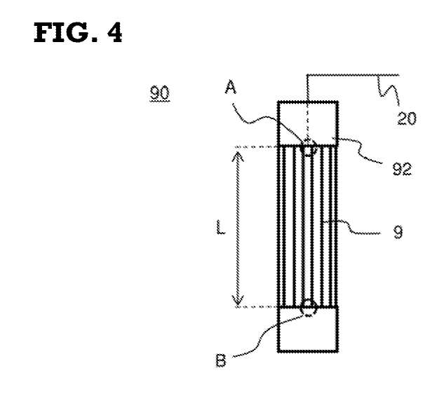

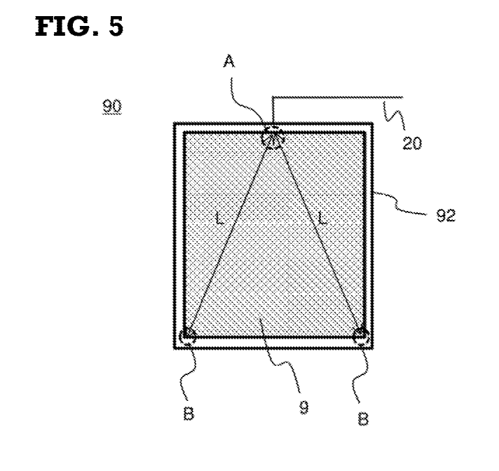

ΔP indicates ozone water injecting inter-membrane differential pressure, and indicates an inter-membrane differential pressure which should be given to a filtration membrane when ozone water treatment is performed. f indicates a coefficient. α indicates un-permeability potential and is a value which indicates a degree of permeability of a filtration membrane. That is, α indicates an inter-membrane differential pressure which is detected by the pressure measuring part 11 in membrane filtrating when a filtration mode is terminated just before a filtration mode is switched to a filtration membrane cleaning mode, and is a maximum inter-membrane differential pressure in membrane filtrating. L indicates a length of a filtration membrane. The filtration membrane 9 shown in FIG. 1 is generally provided as a filtration membrane module 90 in which the filtration membrane 9 is supported as an element by a supporting part 92 as shown in FIG. 4 and FIG. 5. Regarding a length of the filtration membrane L, as shown in FIG. 4 and FIG. 5, among elements of the filtration membrane 9, in a part which is effective for filtration, when an ozone water injection point is set to be a starting point (point A), a length from the point to a point which is the farthest linear dimensions from the point (point B). Regarding a hollow-fiber membrane module shown in FIG. 4 and a flat membrane module shown in FIG. 5, a size of the supporting part 92 is sufficiently smaller than a size of an element of the filtration membrane 9, therefore, generally, as shown in FIG. 4 and FIG. 5, L can be determined considering only an effective part of element of each filtration membrane 9.

In conventional inventions, injection pressure is determined without considering a length of a filtration membrane. According to examination of the inventors of present invention, a length of a filtration membrane is an important factor in determining injection pressure, by injecting a chemical solution with injection pressure which is appropriate to a length of a filtration membrane, a chemical solution can be reliably contacted with whole of a filtration membrane. Pressure loss which is generated by a filtration membrane is in proportion to a length of a filtration membrane, further, it is considered such that the pressure loss is also in proportion to un-permeability potential such as clogging. Consequently, as expressed in equation (1), as a set parameter of inter-membrane differential pressure ΔP which should be generated when ozone water is injected, by introducing a length of a filtration membrane L and a coefficient f, by setting a proper value as a value of a coefficient f, by determining an inter-membrane differential pressure when ozone water is injected, cleaning of a filtration membrane can be effectively performed. Further, regarding a material of a hollow-fiber membrane module and a flat membrane, a material having ozone resistance is preferable, and as a fluorine based organic membrane, polyvinylidene fluoride (PVDF) or poly-tetra-fluoro-ethylene (PTFE) is taken as an example, however, a material is not limited to the above mentioned and any material having ozone resistance and sufficient physical strength which can be resistant to membrane filtration is acceptable.

Further, as a result of the inventors' earnest examination, it is found out such that by injecting ozone water while gradually decreasing a value of ΔP which is obtained by the equation (1) from an initial differential pressure (ΔP₁) which is determined in advance to a final differential pressure (ΔP₂) when ozone water injection treatment is terminated (ΔP₂ [symbol] ΔP₁), ozone water can be contacted efficiently, that is, can be contacted uniformly to an end part of a membrane with small amount of ozone water. That is, it is revealed such that it is good for a range of a coefficient f (will be referred as f₁, ΔP₁=f₁×α×L) when P1 is determined to be a range of 0.15≤f₁≤1.7, preferably, to be a range of 0.2≤f₁≤1.7, and it is good for a range of a coefficient f (will be referred as f₂, ΔP₂=f₂×α×L) when ΔP₂ is determined to be a range of 0≤f₂≤0.15. However, when ΔP₂ is too small, injection pressure will be lacking and injection will be unstable. Further, when ΔP₂ is large, a differential between ΔP₁ is small, and same effect of present invention can be obtained, however, large pressure with large amount of water has to be kept giving, that is, the above mentioned will be uneconomical. Consequently, it is more preferable to be a range of 0.01≤f₂≤0.14, further, it is more preferable to be a range of 0.05≤f₂≤0.1, and f₁ and f₂ will be set individually, and in the above mentioned range, it is good for f₁ and f₂ to be gradually decreased.

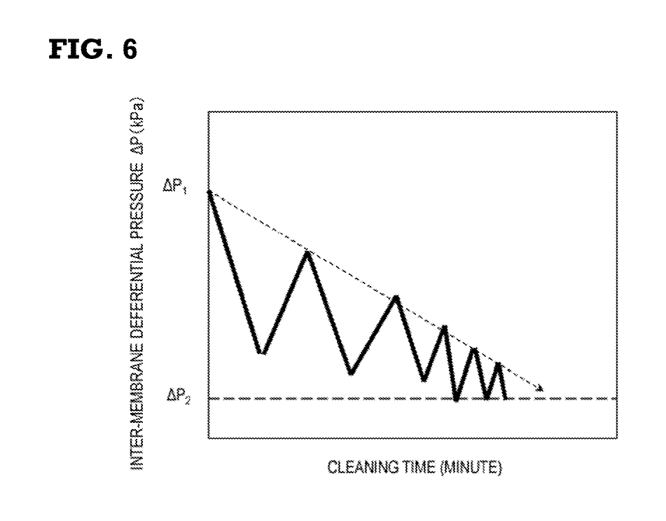

Depending on ozone concentration in ozone water, it is good for ozone water injection time t (minute) to be one minute or longer, preferably, to be a range of 5≤t≤80. Even when ozone water injection time is too long, an effect of present invention will not be lost, however, unnecessary injection is uneconomical. Further, regarding decrease from ΔP₁ to ΔP₂, while injection time t, it may be linearly decreased or may be exponentially decreased (e^{-at}, a [symbol] 0). According to a method for exponentially decreasing a differential pressure, at first, inside of a filtration membrane will be roughly cleaned, as a result, the ratio of recovery of inter-membrane differential pressure is good. Further, in a case where present invention is performed aiming to clean a membrane, by operating for an inter-membrane differential pressure ΔP to be gradually decreased between an initial differential pressure ΔP₁ and a final differential pressure ΔP₂, and to repeat increasing or decreasing in a range, which does not exceed ΔP₁ as shown with a solid line in FIG. 6, high shear strength can be generated on a surface of a filtration membrane, in a short time, ΔP is decreased to be ΔP₂, that is, more effective.

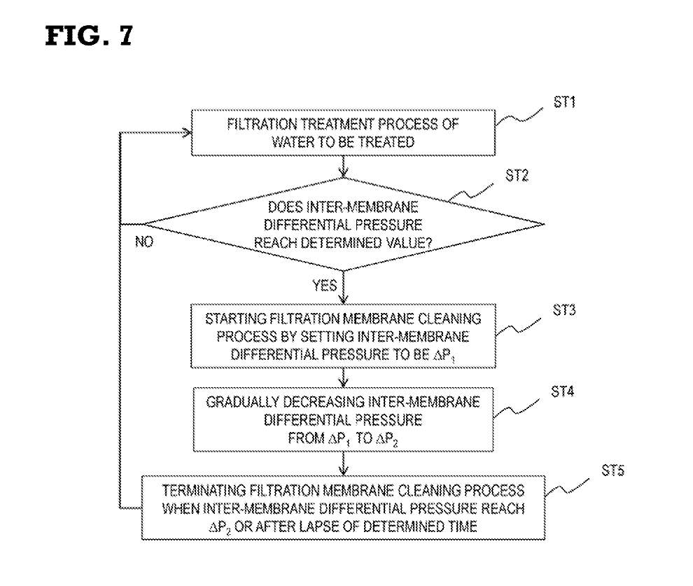

As above mentioned, a flow chart of operation of a membrane filtration device according to Embodiment 1 of present invention will be shown in FIG. 7. First, a membrane filtration device will be operated with a filtration mode. That is, a filtration treatment process (Step ST1) will be performed until an inter-membrane differential pressure α reaches a value which is determined in advance and which requires cleaning (Step ST2 NO). When an inter-membrane differential pressure α reaches a value which requires cleaning (Step ST2 YES), a filtration mode will be switched to a filtration membrane cleaning mode, by ozone water injection treatment, an inter-membrane differential pressure is set to be ΔP₁ and a filtration membrane cleaning process will be started (Step ST3). After that, an inter-membrane differential pressure ΔP is gradually decreased from ΔP₁ to ΔP₂ (Step ST4), at a point when an inter-membrane differential pressure ΔP reaches ΔP₂, a filtration membrane cleaning process will be terminated (Step ST5), again, a filtration treatment process of water to be treated will be performed (Step ST1), that is, a membrane filtration device will be operated with a filtration mode. Further, it is needless to say such that when an inter-membrane differential pressure is controlled to decrease with a fixed ratio, a terminal point of time when an inter-membrane differential pressure ΔP reaches ΔP₂ may be judged based on lapse of time.

As above mentioned, by interlocking the inter-membrane differential pressure controller 13 and the ozone water injection treatment device 12, by injecting ozone water according to a predetermined inter-membrane differential pressure, a filtration membrane can be uniformly contacted with ozone water by using small amount of ozone water, and consequently, cleaning of the filtration membrane 9 can be efficiently completed. Further, when the inter-membrane differential pressure controller 13 has a function for receiving a signal from the pressure measuring part 11 such as PLC or a language controller so as to be able to perform computation of ΔP₁ and ΔP₂, and based on the calculated result, transmitting a signal to the ozone water injection treatment device 12, based on the above-mentioned logic, performing an ozone water injection treatment, the inter-membrane differential pressure controller 13 can be operated automatically, however, in a case where automatic operation is not necessarily required, when a person who takes charge of operation functions a role of the inter-membrane differential pressure controller 13 and performs an ozone water injection treatment manually according to the above-mentioned logic, an effect of present invention can be obtained.

### Embodiment 2

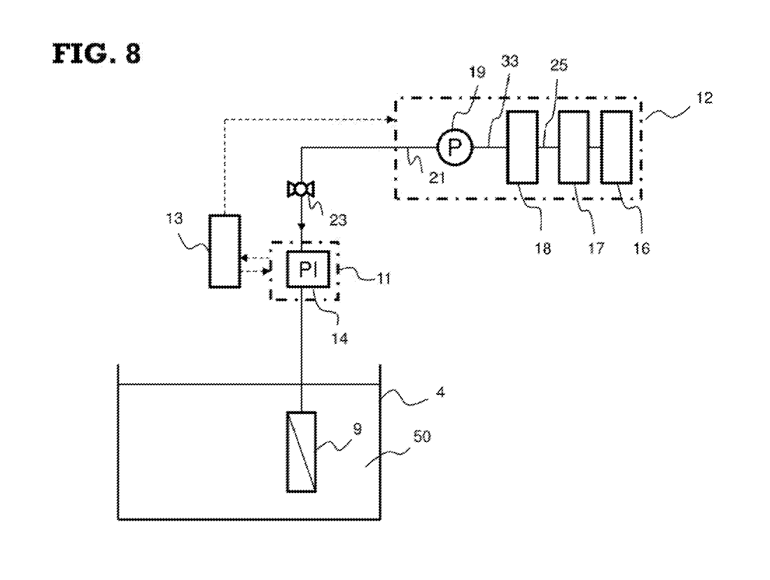

FIG. 8 is a diagram showing a device for performing a manufacturing method of a filtration membrane according to Embodiment 2 of present invention. That is, Embodiment 2 is an embodiment in which present invention is applied to a manufacturing method of a filtration membrane aiming hydrophilization of a hydrophobic organic macromolecular membrane. In the above mentioned case, as shown in FIG. 8, it is not necessary to store activated sludge 5 in a water tank 4, further, it is not necessary to send air by a blower. It is only necessary to store clean water 50 in the water tank 4.

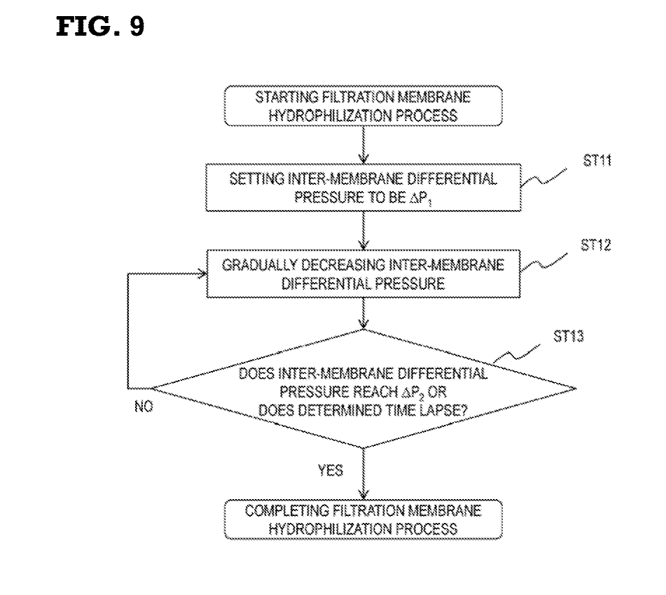

In Embodiment 2, a process which is same as a filtration membrane cleaning process which is described in Embodiment 1 will be performed as a filtration membrane hydrophilization process in a manufacturing method of a filtration membrane. In a filtration membrane hydrophilization process, in the water tank 4 in which the clean water 50 is stored, a filtration membrane 9 to be manufactured, that is, the filtration membrane 9 which is an objective of hydrophilization will be set, and by an ozone water injection treatment device 12, ozone water is passed from a secondary side to a primary side of the filtration membrane 9. FIG. 9 shows a flow chart of a filtration membrane hydrophilization process. First, by ozone water injection treatment, an inter-membrane differential pressure will be set to be ΔP₁, a filtration membrane hydrophilization process will be started (Step ST11). After that, an inter-membrane differential pressure ΔP will be gradually decreased from ΔP₁ to ΔP₂ (Step ST12), and at a point when ΔP reaches ΔP₂ (Step ST4 YES), performing of a filtration membrane hydrophilization process will be completed (Step ST5).

Regarding the way of decreasing an inter-membrane differential pressure ΔP gradually from ΔP₁ to ΔP₂, as described in Embodiment 1, it may be linearly decreased or may be exponentially decreased. Further, as shown in FIG. 6, by repeating decrease and increase, it may be decreased step by step.

As described in Embodiment 1, at this time, in a case where un-permeability potential of a filtration membrane is α, a length of a filtration membrane is L when a filtration membrane hydrophilization process starts, by introducing a coefficient f, an inter-membrane differential pressure ΔP may be determined by α×L×f.

When a coefficient f for determining an initial membrane differential ΔP₁ is set to be f₁ and a coefficient f for determining a final membrane differential pressure is set to be f₂, f₁may be 0.15 or larger, or less than 1.7, and f₂ may be 0 or larger, or less than 0.15.

Further, in this case, it is not always necessary to measure un-permeability potential α of all filtration membranes. That is, in a case where quality is stable at a manufacturing stage, it is sufficient to measure un-permeability potential α of at least one filtration membrane per each lot, and regarding other filtration membrane module which constitutes a lot, by using a value of the same α, a filtration membrane hydrophilization process may be performed.

As above mentioned, in Embodiment 2, present invention is applied to a filtration membrane hydrophilization process in a manufacturing method of a filtration membrane, ozone water uniformly can be contacted to an end part of a membrane with small amount of ozone water, as a result, a method for efficiently manufacturing a filtration membrane can be provided.

### EXAMPLE

Hereinafter, in a filtration membrane device which is described in Embodiment 1, an example in which after water to be treated is filtrated, cleaning of a filtration membrane is performed by ozone water injection treatment which is based on present invention, and a comparative example in which cleaning of a filtration membrane is performed by ozone water injection treatment which is not based on present invention will be described.

### Example 1

By using a membrane having a length of 1.2 m of module L, according to a membrane separation activated sludge method having the configuration which is same as that shown in FIG. 1, a membrane filtration treatment is performed. When an inter-membrane differential pressure α reaches 30 kPa, performing of a filtration treatment is stopped, ozone water having concentration of 50 mgO₃/L is generated, by an ozone water injection treatment device 12, ozone water is injected from a secondary side to a primary side of a membrane module. An inter-membrane differential pressure in injecting can be obtained by equation (1), by changing a value of f₁ in a range of 0.13 to 1.8, cleaning effects are compared. A cleaning effect is evaluated by recovery ratio of an inter-membrane differential pressure, and recovery ratio is calculated according to following equation. That is, by using an inter-membrane differential pressure just after a filtration treatment is started (Pa) and an inter-membrane differential pressure just after a filtration treatment is re-started after a cleaning treatment is completed (Pb), recovery ratio of an inter-membrane differential pressure is calculated by following equation (2).

Recovery Ratio of Differential Pressure (%)=[1−{(Pa−Pb)/30}]×100 (2)

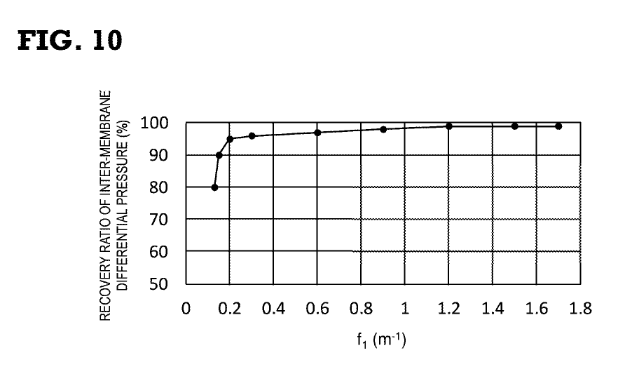

A length of cleaning time is fixed to be 30 minutes and a value of f₂ is fixed to be 0.14. Further, a cleaning treatment is performed automatically by an inter-membrane differential pressure controller for 30 minutes so as for an inter-membrane differential pressure ΔP to decrease linearly from ΔP₁ to ΔP₂. α is 30 kPa. Obtained result will be shown in FIG. 10. According to the result shown in FIG. 10, when f₁ is 0.14, pushing pressure of ozone water is too small, ozone water cannot be reached to an end of a membrane, therefore cleaning is not sufficient. On the other hand, when f₁ is 1.8, pushing pressure of ozone water is too large, a membrane is damaged. Consequently, f₁ may be 0.15≤f₁≤1.7, preferably f₁ may be 0.2≤f₁≤1.7.

### Example 2

By using a membrane having a length of 1.2 m of module L, according to a membrane separation activated sludge method having the configuration which is same as that shown in FIG. 1, a membrane filtration treatment is performed. When an inter-membrane differential pressure α reaches 30 kPa, performing of a filtration treatment is stopped, ozone water having concentration of 50 mgO₃/L is generated, by an ozone water injection treatment device 12, ozone water is injected from a secondary side to a primary side of a membrane module. An inter-membrane differential pressure in injecting can be obtained by equation (1), by changing a value of f₂ in a range of 0.05 to 0.15, cleaning effects are compared. By using an inter-membrane differential pressure (Pa) just after a filtration treatment is started and an inter-membrane differential pressure (Pb) just after a filtration treatment re-started after a cleaning treatment is completed, recovery ratio of an inter-membrane differential pressure is calculated by equation (2), and cleaning effects are evaluated by recovery ratio of an inter-membrane differential pressure. A value of f₁ is set to be 0.15 and a length of cleaning time is set to be 30 minutes.

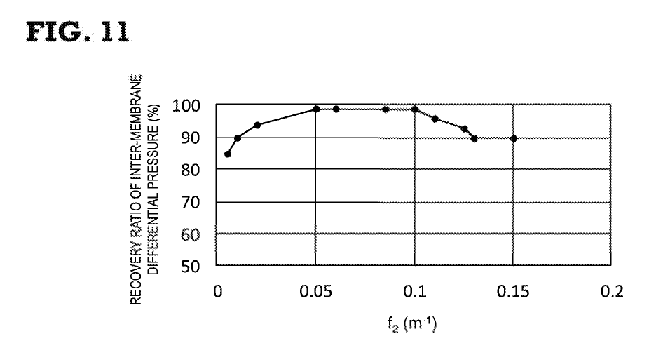

Obtained result will be shown in FIG. 11, When f₂ is set to be 0.005, as a cleaning treatment is advanced, an inter-membrane differential pressure is decreased too much, an inter-membrane differential pressure will not be sufficient, therefore, ozone injection will be unstable, as a result, recovery ratio of an inter-membrane differential pressure is decreased. On the other hand, when f₂ is set to be 0.15, that is, f₂ is set to be a same value of f₁, that is, when ΔP₁ and ΔP₂ is maintained to be equal, an inter-membrane differential pressure when ozone water is injected is maintained to be a fixed value, excellent effect of cleaning of a membrane can be obtained, however, in order to maintain for pressure to be high, an ozone water injection amount has to be increased, that is, the above mentioned is uneconomical. Consequently, ΔP₂ should be set to be smaller than ΔP₁, f₂ may be 0.01≤f₂ ≤0.15, preferably f₂ may be 0.02≤f₂≤0.1.

### Example 3

By using a membrane having a length of 1.2 m of module L, according to a membrane separation activated sludge method having the configuration which is same as that shown in FIG. 1, a membrane filtration treatment is performed. When an inter-membrane differential pressure α reaches 30 kPa, performing of a filtration treatment is stopped, ozone water having concentration of 50 mgO₃/L is generated, by an ozone water injection treatment device 12, ozone water is injected from a secondary side to a primary side of a membrane module. By setting a value of f₁ to be 0.3, by setting a value of f₂ to be 0.05, by changing a length of cleaning time from 0.5 minutes to 100 minutes, recovery ratio of an inter-membrane differential pressure is evaluated.

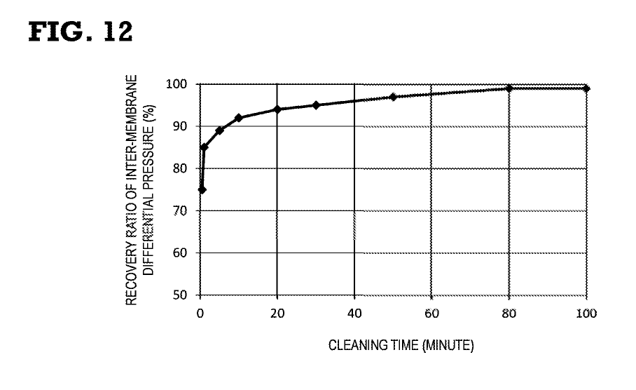

Obtained result will be shown in FIG. 12. When a length of cleaning time t is 0.5 minutes, recovery ratio of an inter-membrane differential pressure is 75%, that is, low. Further, when a length of cleaning time t is longer than one minute, excellent cleaning effect can be obtained. On the other hand, when a length of cleaning time t is longer than 80 minutes, there is no change regarding cleaning effect, therefore, it is revealed such that as a length of cleaning time, length of 1 to 80 minutes is sufficient.

### Example 4

By using a membrane having a length of 1.2 m of module L, according to a membrane separation activated sludge method having the configuration which is same as that shown in FIG. 1, a membrane filtration treatment is performed. When an inter-membrane differential pressure α reaches 30 kPa, performing of a filtration treatment is stopped, ozone water having concentration of 50 mgO₃/L is generated, by an ozone water injection treatment device 12, ozone water is injected from a secondary side to a primary side of a membrane module. By setting a value of f₁ to be 0.3, by setting a value of f₂ to be 0.05, by setting a length of cleaning time to be 30 minutes, from ΔP₁ to ΔP₂, an inter-membrane differential pressure in cleaning is linearly decreased for 30 minutes.

### Example 5

Under the condition which is same as that of Embodiment 4, an inter-membrane differential pressure in cleaning is exponentially decreased from ΔP₁ to ΔP₂, for 30 minutes.

### Example 6

Under the condition which is same as that of Embodiment 4, from ΔP₁ to ΔP₂, in a range which does not exceed ΔP₁, so as for ΔP to be a maximal value or a minimal value alternatively, every four minutes, an inter-membrane differential pressure ΔP is decreased step by step by repeating increase and decrease.

### Comparative Example 1

By using a membrane having a length of 1.2 m of module L, by setting an inter-membrane differential pressure α to be 30 kPa, by setting the upper limit of an inter-membrane differential pressure in cleaning to be 5 kPa, by setting the lower limit of an inter-membrane differential pressure in cleaning to be 3.6 kPa, by setting a length of cleaning time to be 30 minutes, and by setting ozone water concentration to be 50 mg/L, a cleaning process using ozone water is performed by using alternately the upper limit of pressure and the lower limit of pressure in cleaning every 4 minutes.

### Comparative Example 2

By using a membrane having a length of 1.2 m, of module L, by setting an inter-membrane differential pressure α to be 30 kPa, by setting ozone water concentration to be 50 mg/L, while a differential pressure is maintained to be 95 kPa, a cleaning process is performed using ozone water.

### Comparative Example 3

By using a membrane having a length of 1.2 m of module L, by setting an inter-membrane differential pressure α to be 30 k Pa, by setting ozone water concentration to be 50 mg/L, while a differential pressure is maintained to be 19 kPa, a cleaning process is performed using ozone water.

### Comparative Example 4

By using a membrane having a length of 1.2 m of module L, by setting an inter-membrane differential pressure α to be 30 kPa, by setting the upper limit of an inter-membrane differential pressure in cleaning to be 19 kPa by setting the lower limit of an inter-membrane differential pressure in cleaning to be 7.2 kPa, by setting a length of cleaning time to be 30 minutes, and by setting ozone water concentration to be 50 mg/L, a cleaning process using ozone water is performed by using alternately the upper limit of pressure and the lower limit of pressure in cleaning, every 4 minutes.

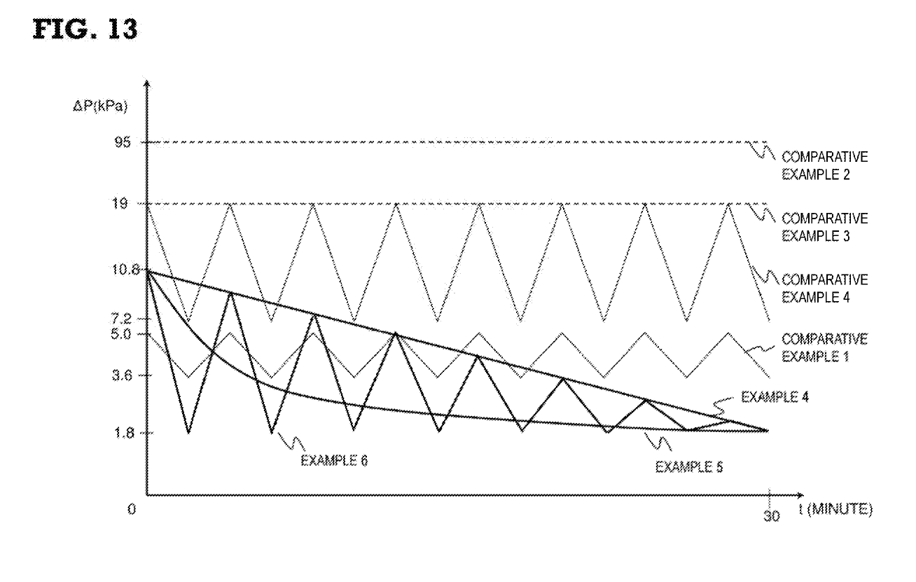

Transition of an inter-membrane differential pressure in cleaning with ozone water in Examples 4 to 6 and Comparative Examples 1 to 4 will be shown in FIG. 13.

Results of Examples 4 to 6 and Comparative Examples 1 to 4 will be shown in Table 1. In Examples 4 to 6 to which present invention is applied, high recovery ratio of an inter-membrane differential pressure can be obtained. Especially, according to a cleaning method of Example 6, the highest recovery ratio of an inter-membrane differential pressure is obtained. On the other hand, in Comparative Examples 1 to 4, a membrane is damaged, recovery ratio of an inter-membrane differential pressure is low, and an amount of ozone injection is large, that is, the operation is not effective.

TABLE 1

| | RECOVERY RATIO | |
|---|---|---|
| | OF INTER- | |
| | MEMBRANE | INJECTION |
| | DIFFERENTIAL | OZONE |
| | PRESSURE | AMOUNT |
| | (%) | (Go3) |
| EXAMPLE 4 | 95 | 7.5 |
| EXAMPLE 5 | 97 | 7.5 |
| EXAMPLE 6 | 99 | 7.5 |
| COMPARATIVE EXAMPLE 1 | 80 | 7.5 |
| COMPARATIVE EXAMPLE 2 | DAMAGED | — |
| COMPARATIVE EXAMPLE 3 | 95 | 11 |
| COMPARATIVE EXAMPLE 4 | 95 | 10.5 |

By considering a length of a membrane and by maintaining a value of f₁ and f₂ to be a proper range, by adding proper pressure and by passing ozone water from a secondary side to a primary side of a filtration membrane, excellent cleaning effect can be obtained. As above mentioned, it is clear such that present invention is superior to conventional inventions.

Further, it is understood such that in present invention, combination of each embodiment proper arrangement or omitting may be resorted to without departing from the spirit and scope thereof.

### DESCRIPTION OF REFERENCE SIGNS

1. membrane filtration device

2. water to be treated

9. filtration membrane

12. ozone water injection treatment device

13. inter-membrane differential pressure controller

17. ozone concentrator

1: A membrane filtration device having a filtration mode in which by passing water to be treated from a primary side to a secondary side of a filtration membrane, the water to be treated is filtrated, and a filtration membrane cleaning mode in which by passing ozone water from the secondary side to the primary side of the filtration membrane, the filtration membrane is cleaned, and
comprising an inter-membrane differential pressure controller which controls an inter-membrane differential pressure ΔP which is a differential between liquid pressure at the primary side of the filtration membrane and liquid pressure at the secondary side of the filtration membrane,
wherein in the filtration membrane cleaning mode the inter-membrane differential pressure controller controls to gradually decrease the inter-membrane differential pressure ΔP from an initial differential pressure ΔP₁ which is set in advance to a final differential pressure ΔP₂ which is a value smaller than a value of the P₁.

2: The membrane filtration device according to claim 1, wherein the inter-membrane differential pressure controller controls the inter-membrane differential pressure from the initial differential pressure ΔP₁ to the final differential pressure ΔP₂ , step by step by repeating decreasing the inter-membrane differential pressure and increasing the inter-membrane differential pressure.

3: The membrane filtration device according to claim 1, wherein the inter-membrane differential pressure controller determines the inter-membrane differential pressure ΔP according to f×α×L when un-permeability potential is α when the filtration membrane cleaning process starts, length of the filtration membrane is L and a coefficient f is introduced.

4: The membrane filtration device, according to claim 3, wherein the coefficient f for determine the initial differential pressure ΔP₁ is set to be f₁, and the coefficient f for determining the final differential pressure ΔP₂ is set to be f₂, f₁ is set to be a value which is 0.15 or larger and 0.17 or smaller, and f₂ is set to be a value which is larger than 0 and is 0.15 or smaller.

5. A filtration membrane cleaning method comprising a filtration treatment process in which by passing water to be treated from a primary side to a secondary side of a filtration membrane, the water to be treated is filtrated and a filtration membrane cleaning process in which by passing ozone water from the secondary side to the primary side of the filtration membrane so as to clean the filtration membrane.
wherein in the filtration membrane cleaning process, an inter-membrane differential pressure ΔP which is a differential between liquid pressure at the primary side of the filtration membrane and liquid pressure at the secondary side of the filtration membrane is gradually decreased from an initial differential pressure ΔP₁ which is set in advance to a final differential pressure ΔP₂ which is a value smaller than a value of the ΔP₁.

6. The filtration membrane cleaning method according to claim 5, wherein the inter-membrane differential pressure is controlled step by step by repeating decreasing the inter-membrane differential pressure and increasing the inter-membrane differential pressure from the initial differential pressure ΔP₁ to the final differential pressure ΔP₂.

7: The filtration membrane cleaning method according to claim 5, wherein the inter-membrane differential pressure ΔP is determined according to f×α×L wherein un-permeability potential is α when the filtration membrane cleaning process starts, length of the filtration membrane is L and a coefficient f is introduced.

8: The filtration membrane cleaning method according to claim 7, wherein the coefficient f for determining the initial differential pressure ΔP₁ is set to be f₁, and the coefficient f for determining the final differential pressure ΔP₂ is set to be f₂, f₁ is set to be a value which is 0.15 or larger and 0.17 or smaller, and f₂ is set to be a value which is larger than 0 and is 0.15 or smaller.

9: A method for manufacturing a filtration membrane for filtrating liquid by passing the liquid from a primary side to a secondary side
comprising a filtration membrane hydrophilization process in which by passing ozone water from the secondary side to the primary side of the filtration membrane so as to hydrophilize the filtration membrane,
wherein in the filtration membrane hydrophilization process, an inter-membrane differential pressure ΔP which is a differential between liquid pressure at the primary side of the filtration membrane and liquid pressure at the secondary side of the filtration membrane is gradually decreased from an initial differential pressure ΔP₁ which is set in advance to a final differential pressure ΔP₂ which is a value smaller than a value of the ΔP₁ so as to pass ozone water.

10: The method for manufacturing a filtration membrane according to claim 9, wherein an inter-membrane differential pressure is decreased step by step by repeating decreasing an inter-membrane differential pressure and increasing an inter-membrane differential pressure from the initial differential pressure ΔP₁ to the final differential pressure ΔP₂.

11: The method for manufacturing a filtration membrane according to claim 9, wherein the inter-membrane differential pressure ΔP is determined according to f×α×L wherein un-permeability potential is α when the filtration membrane cleaning process starts, length of the filtration membrane is L and a coefficient f is introduced.

12: The method for manufacturing a filtration membrane according to claim 11, wherein the coefficient f for determining the initial differential pressure ΔP₁ is set to be f₁, and the coefficient f for determining the final differential pressure ΔP₂ is set to be f₂, f₁ is set to be a value which is 0.15 or larger and 0.17 or smaller, and f₂ is set to be a value which is larger than 0 and is 0.15 or smaller.

13: The membrane filtration device according to claim 2, wherein the inter-membrane differential pressure controller determines the inter-membrane differential pressure ΔP according to f×α×L when un-permeability potential is α when the filtration membrane cleaning process starts, length of the filtration membrane is L and a coefficient f is introduced.

14. The membrane filtration device according to claim 13, wherein the coefficient f for determining the initial differential pressure ΔP₁ is set to be f₁, and the coefficient f for determining the final differential pressure ΔP₂ is set to be f₂, f₁ is set to be a value which is 0.15 or larger and 0.17 or smaller, and f₂ is set to be a value which is larger than 0 and is 0.15 or smaller.

15. The filtration membrane cleaning method according to claim 6, wherein the inter-membrane differential pressure ΔP is determined according to f×α×L wherein un-permeability potential is α when the filtration membrane cleaning process starts, length of the filtration membrane is L and a coefficient f is introduced.

16. The filtration membrane cleaning method according to claim 15, wherein the coefficient f for determining the initial differential pressure ΔP₁ is set to be f₁, and the coefficient f for determining the final differential pressure ΔP₂ is set to be f₂, f₁ is set to lie a value which is 0.15 or larger and 0.17 or smaller, and f₂ is set to be a value which is larger than 0 and is 0.15 or smaller.

17: The method for manufacturing a filtration membrane according to claim 10, wherein the inter-membrane differential pressure ΔP is determined according to f×α×L wherein un-permeability potential is α when the filtration membrane cleaning process starts, length of the filtration membrane is L and a coefficient f is introduced.

18: The method for manufacturing a filtration membrane according to claim 17, wherein the coefficient f for determining the initial differential pressure ΔP₁ is set to be f₁, and the coefficient f for determining the final differential pressure ΔP₂ is set to be f₂, f₁ is set to be a value which is 0.15 or larger and 0.17 or smaller, and f₂ is set to be a value which is larger than 0 and is 0.15 or smaller.
